(19) United States
(12) Patent Application Publication
(10) Pub. No.: US 2018/0002975 A1
(43) Pub. Date: Jan. 4, 2018

(54) GARAGE DOOR WITH OPERABLE ROTATING AND RETRACTABLE PANELS

(71) Applicants: Stephanie Taylor, Miami, FL (US); Johnathan Taylor, Miami, FL (US); Larry Gene Taylor, SR., Boca Raton, FL (US)

(72) Inventors: Stephanie Taylor, Miami, FL (US); Johnathan Taylor, Miami, FL (US); Larry Gene Taylor, SR., Boca Raton, FL (US)

(21) Appl. No.: 15/198,870

(22) Filed: Jun. 30, 2016

(51) Int. Cl. E06B 7/09; E05F 15/72; E06B 3/70

(52) U.S. Cl. CPC E06B 7/09; E06B 3/70; E05F 15/72; E06B 2003/7044

(57) ABSTRACT

A garage door apparatus is described as having a one or more rotating panel. This rotating panel can also retract into the surrounding garage door structure to create an opening in the garage door. The panels may be rotated and/or retracted automatically by a user or as directed by monitoring software. A user may operate the apparatus through a specially programmed wireless communication device enabled with a user interface and coupled via a communications network. Alternatively, the user may choose to program the apparatus to react automatically based upon environmental inputs such as the detection of unsafe levels of Carbon Monoxide, excessive temperatures, or rain.

### CROSS-REFERENCE TO RELATED APPLICATIONS

None

### FIELD OF THE INVENTION

The invention disclosed broadly relates to the field of building structures, and more particularly relates to the field of apparatus, systems, and methods of providing selectively open areas in garage doors through implementation of rotating and retractable panels.

### BACKGROUND OF THE INVENTION

It is a common experience for a homeowner to enjoy the space and convenience of their garage. In good weather, this covered space may be enjoyed with the garage door open, effectively creating a covered patio, game area, or just more square footage within which to enjoy life. It is not always desirable, however to keep the garage door open. Whether for safety reasons, or just because the weather is bad, the enjoyment of the garage is often curtailed due to having to keep the garage door closed. Heat buildup, lack of ventilation, or even lack of visibility to the outside are just some of the drawbacks of a traditional garage door.

Prior attempts in the art have been made to address some of these issues. For example, the addition of a window into the door allows for light and visibility, but does not help with ventilation. Louvered slats allow for airflow, but still obstruct visibility. Hinged panels, or doors-within-the-door, are plainly impractical.

Furthermore, prior attempts in the art to address these problems and shortcomings, merely provide mechanical solutions. For example, louvered slats may be convenient forms of accounting for ventilation, but will still need to be manually opened and closed.

Therefore, there is a need for an apparatus, system, and method for providing a garage door with operable rotating and retractable panels, which aims to overcome the above-stated shortcomings of the known art.

### SUMMARY

In this specification and in the appended claims and drawings, words and phrases have the meanings commonly attributed to them in the relevant art except as otherwise specified herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In view of the foregoing, a preferred embodiment of the present invention is directed to a garage door apparatus with a one or more panel integral to the garage door structure. This one or more panel is rotably operable with respect to the surrounding garage door structure, such that as the panel is rotated it presents an opening in the garage door structure. This rotably operable panel is also selectively retractable into the garage door structure such that a substantially unobstructed opening may be left in the garage door structure.

Further embodiments of the present invention include electronic actuation means operably coupled to the rotable and retractable panels. In this way, the one or more panels may be rotated and/or retracted automatically by a user or as directed by monitoring software.

Embodiments of the invention further contemplate logic and sensor means operably coupled to the apparatus so that a user may operate the apparatus through a specially programmed wireless communication device enabled with a user interface and communicatively coupled via a communications network. Alternatively, the user may choose to program the apparatus to react automatically based upon environmental inputs such as the detection of unsafe levels of Carbon Monoxide, excessive temperatures, or rain.

### BRIEF DESCRIPTION OF THE SEVERAL VIEWS OF THE DRAWINGS

To describe the foregoing and other exemplary purposes, aspects, and advantages, we use the following detailed description of an exemplary embodiment of the disclosure with reference to the drawings, in which:

FIG. 1 is a representation of an apparatus according to one embodiment of the present disclosure;

FIG. 2 is a composite of cross-sectional detail views of an apparatus, according to an embodiment of the present disclosure;

FIG. 3 is simplified representation of system showing a user communicating with the apparatus via a data network, according to an embodiment of the present invention; and

FIG. 4 is a simplified block diagram of an electronics control module of the apparatus, according to an embodiment of the present disclosure.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present disclosure.

### DETAILED DESCRIPTION

In the Summary above, in the Description below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, structures, steps, etc. are optionally present. For example, an article “comprising” (or “which comprises”) components A, B, and C can consist of (i.e., contain only) components A, B, and C, or van contain not only components A, B, and C, but also one or more other components or structures.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40% means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein. Specifically, component names, types, and values, as depicted in the exemplary schematic diagrams, are not intended to limit the scope of the present invention and are presented only as possible embodiments.

While the specification will conclude with claims defining the features of embodiments of the invention that are regarded as novel, it is believed that the invention will be better understood from a consideration of the following description in conjunction with the figures, in which like reference numerals are carried forward.

Before describing, in detail, embodiments that are in accordance with the present disclosure, it should be observed that some of the embodiments may reside primarily in combinations of method steps and system components related to systems and methods for placing computation inside a communication network. Accordingly, the system components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible computing or communications embodiment may not be depicted in order to facilitate a less obstructed view of these various embodiments.

Apparatus 100

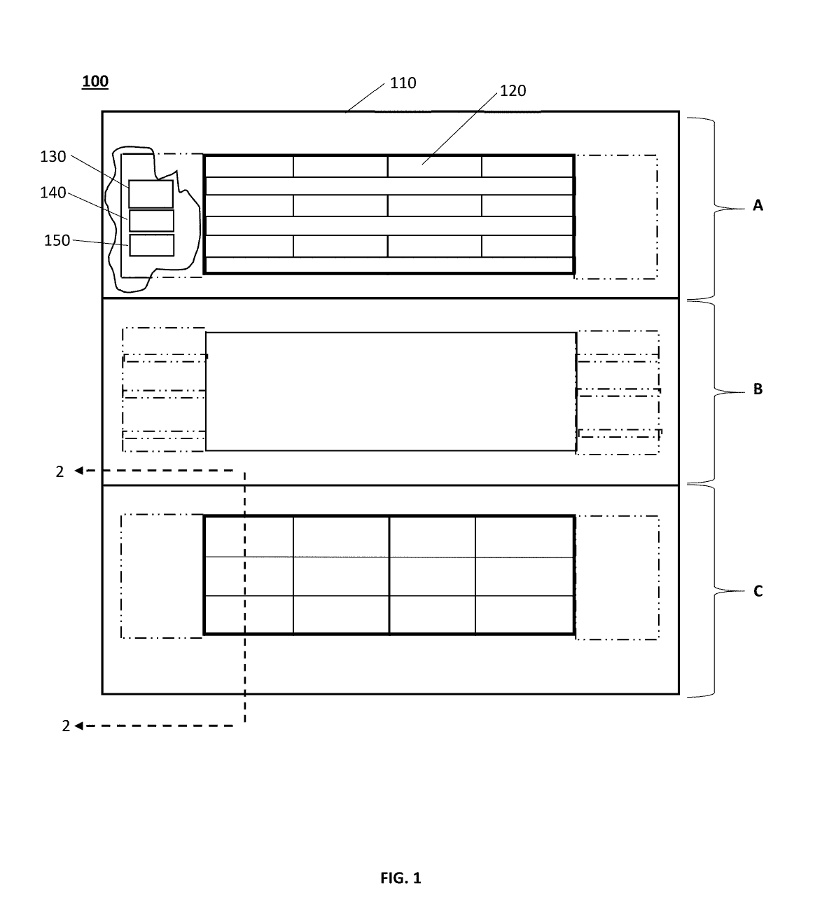

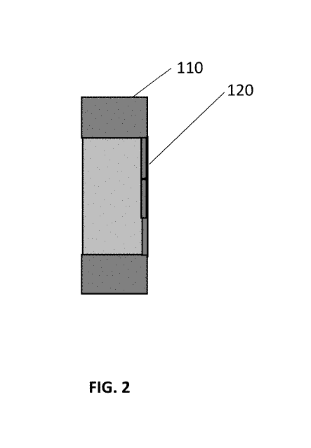

Referring now in specific detail to the drawings, and to FIG. 1 in particular, there is shown a simplified block diagram illustrating, according to an embodiment of the present disclosure, an apparatus 100 comprising a garage door 110, a one or more panel 120 integral to the garage door 110, a rotating means 130 integral to the garage door and operably coupled to the one or more panel 120, and a retracting means 140 integral to the garage door 110 and operably coupled to the one or more panel 120.

By way of example and not limitation, FIG. 1 illustrates an embodiment of the invention where the apparatus 100 is comprised of a three-section garage door 110. Each section incorporates a multiple of panel 120 as well as integral rotating means 130 and retracting means 140. Section A illustrates the one or more panel 120 in the rotated but not retracted state. Section B illustrates the one or more panel 120 in the rotated and retracted state. Section C illustrates the one or more panel 120 in the closed state (not rotated, and not retracted).

Garage Door 110

The garage door 110 described here is a substantially planar structure having at least an outward facing surface (the surface typically facing the driveway), an interior facing surface (the surface typically facing the inside of the garage), and an inner structure between the outward facing surface and the interior facing surface. The inner structure has a thickness (the linear distance between the plane defined by the outward facing surface and the plane defined by the inside facing surface) configured to accept the other components described herein integral thereto.

The garage door 110 is depicted in FIG. 1 as having three sections (A, B, and C), but it is within the scope of the embodiments presented herein that the garage door 110 may have any number of sections, but at least one section is preferred. The other components of the apparatus are contemplated to be integral to each one section of the garage door 110 component (as is illustrated in the embodiment shown in FIG. 1).

Panel 120

Panel 120, as illustrated in FIG.1, is a substantially planar component configured to selectively and operably rotate in place relative to the garage door 110, and retract into the garage door 110. Embodiments of the present invention include at least one rotating and retracting panel 120, integral to the garage door 110. A preferred embodiment of the present invention comprises a plurality of panels 120, each configured to be integral to the garage door 110, and operably coupled to mechanical, or electromechanical, subsystems that rotate and/or retract the plurality of panel 120 with respect to the surrounding garage door 110 structure.

Embodiments of panel 120 include solid structure as well as extrusions and nesting, or telescoping, structures. It is contemplated to be within the scope of the invention for panel 120 to be opaque, transparent, or semi-opaque, or semi-transparent.

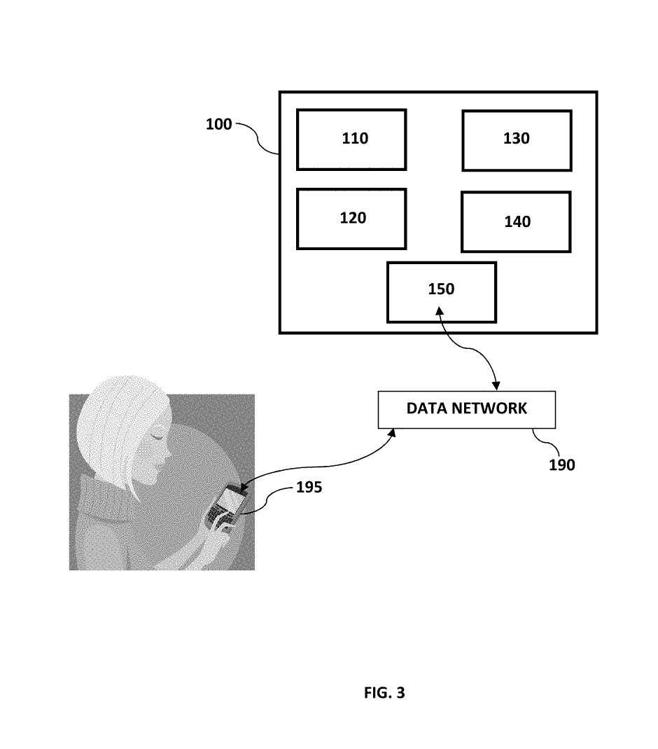

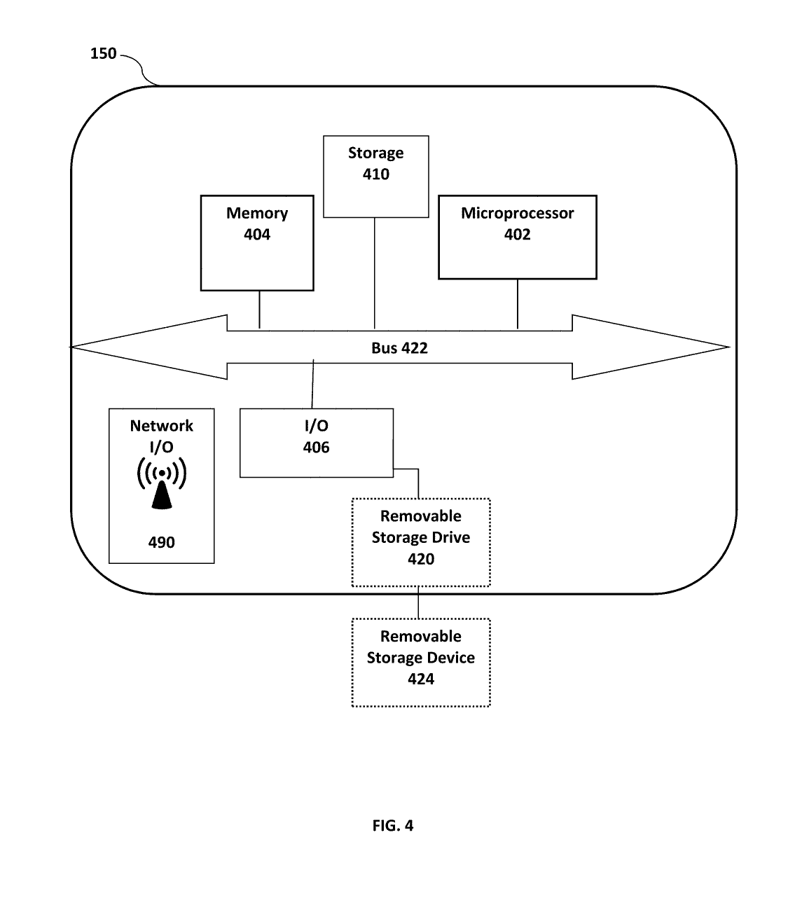

Section A-A of FIG. 1 is illustrated in multiple detailed views as shown in FIG. 2.

It is contemplated to be within the scope of the present invention for the rotation capability and the retraction capability to be combined in one embodiment, or, alternatively, used exclusively one or the other in different embodiments. A preferred embodiment discloses a one or more panel that is configured to rotate (from a closed position, to an open position, or some position in between), as well as retract in order to create a completely open, unobstructed, aperture in the garage door.

The operable panels 120 could be automatically opened with an electrical switch, remote control, mobile device, or manually opened. While the embodiments shown in the various figures illustrate panels in a horizontal configuration, it is contemplated to be within the scope and spirit of the present disclosure that the panels 120 may be configured and operable in either a horizontal or vertical direction.

Rotating Means 130

The rotating means 130 disclosed here is meant to include such mechanical, or electro-mechanical, devices as may be known in the art. For example, it is known in the art to use a rack and pinion mechanism, mechanically attached to the one or more panel 120, such that the relative motion of the rack and pinion is translated into a rotation of the one or more panel 120. Other rotating means 130 may include direct drive motors, or servos, communicative with the one or more panel 120. Said rotating means 130 may be electrically actuated, mechanically actuated, or some electro-mechanical combination. Embodiments of the invention contemplate rotating means 130 that are integral to the garage door. In this way, the mechanisms are safely contained within the inner and outer surfaces of the garage door. Other embodiments of the invention may include a rotating means 130 that is partially or entirely outside of the garage door.

Retracting Means 140

The retracting means 140 disclosed here is meant to include such mechanical, or electro-mechanical, devices as may be known in the art. For example, it is known in the art to use a rack and pinion mechanism, where the rack is mechanically integral to the one or more panel 120 and the rotation of the pinion retracts or extends the one or more panel 120 with respect to the pinion location. The retracting means 140 may also include motors, servos, pulleys, or other electrical and/or mechanical means configured to retract and extend the one or more panel 120. The retracting means 140 are contemplated to be integral to the garage door, between the inner and outer surfaces of the garage door. Other embodiments of the invention may include a retracting means 140 that is partially or entirely outside of the garage door.

Electronics and Control Module 150

Further embodiments of the apparatus 100 may also comprise an electronics and control module (ECM) 150. This ECM is operably coupled to the rotating means 130 as well as the retracting means 140. The ECM may be configured to provide electrical power to the rotating means 130 and the retracting means 140. The ECM may also be configured with sensors and logic circuits in order to perform various additional functions. For example, embodiments of the invention may be configured with a one or more carbon monoxide sensor. This sensor would be electrically coupled with the ECM such that, when the ECM detects buildup of carbon monoxide in the garage, the ECM logic circuit sends a signal for the rotating means 130 to actuate the one or more panel 120 into an open position, thereby ventilating the garage. When the ECM detects that the carbon monoxide levels have reduced to a safe level, the ECM may, optionally, re-close the one or more panel 120. Other such sensors may include, by way of illustration and not limitation, temperature sensors and rain sensors.

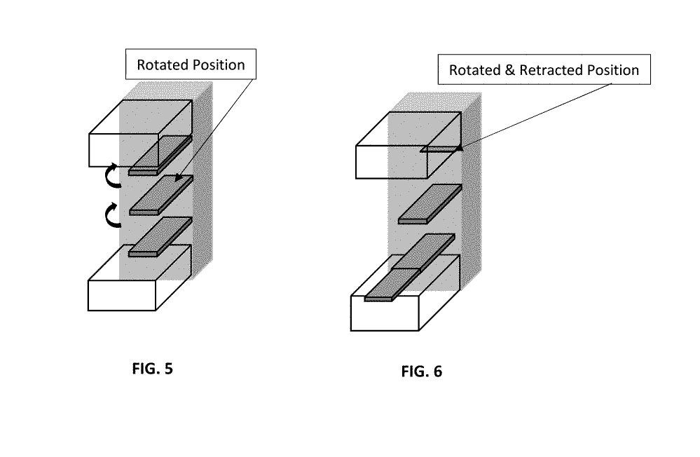

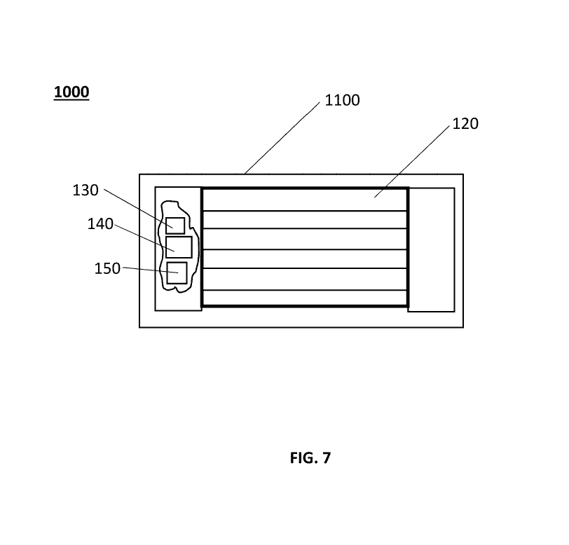

Still further embodiments of the apparatus 100 may also comprise dedicated hardware and software for enabling wireless communication over a network, as illustrated in FIG. 3. In such an embodiment, the ECM 150 may further comprise dedicated hardware and software so that the apparatus 100 appears as a node on a data network 190. Another node on the data network, such as a specially programmed computing device 195, may then communicate with the apparatus via the ECM. In this way, a person utilizing the specially programmed computing device may, for example, monitor the position of the panels (open, closed, partially opened, etc.). Additional information may be communicated by the ECM, such as data from the one or more sensors.

By way of illustration, and not limitation, an embodiment of the apparatus may be configured as a Bluetooth-enabled device. A homeowner may download and install a mobile application onto a Bluetooth-enabled mobile computing device, thereby converting the device into a specially programmed computing device. Through a user interface provided by the mobile application, the user may view the status of the apparatus, open or close the panels, view alerts, or set operation parameters for the apparatus.

Further embodiments of the apparatus are configured to place the apparatus as a node on a local area network, or as a node accessible via a wide area network, or even the Internet.

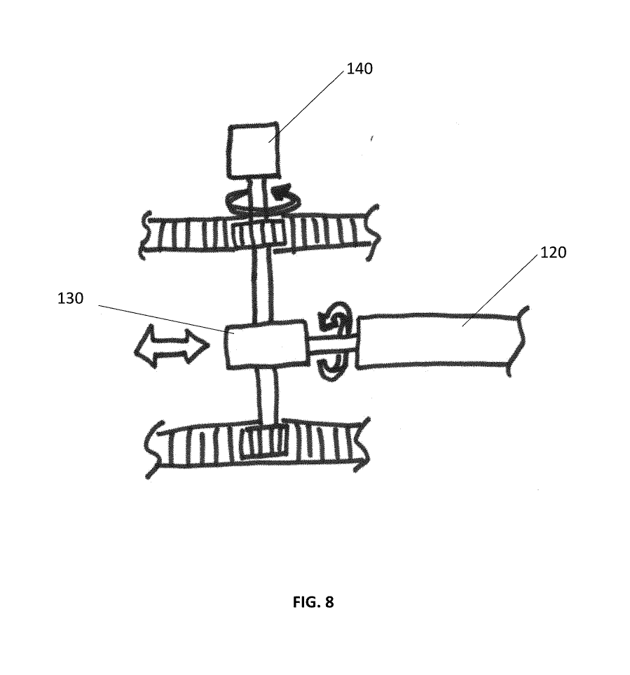

The ECM 150 components can be realized each as one or more computing devices, executing a variety of scripts, databases, processes, and related components. Components of the ECM 150 shown in FIG. 4 are for illustrative purposes only, to facilitate an understanding of the services and features of ECM 150. One with knowledge in the art will appreciate that the components may represent all hardware components, all software components, or a combination of hardware and software components.

The Data Network 190 comprises a single or a plurality of connected data networks, including private and public networks, including the Internet, and such networks may or may not be comprised of circuits or components across multiple business entities, service providers, physical and protocol layer data networking methods and technologies, and located across diverse physical locations.

In one embodiment, referring now to FIG. 4, the ECM 150 comprises a physical computing device configured with network connectivity, such as Ethernet IEEE 802.3, Wireless such as IEEE 802.11, Bluetooth, ZigBee, or Cellular Wireless such as GSM. Such dedicated computing device further comprises a microprocessor device 402 which communicates with an input/output subsystem 406, memory 404, storage 410 and network interface 490. The microprocessor device 402 is operably coupled with a communication infrastructure herein represented as bus 422. Bus 422 is a simplified representation of the communication infrastructure required in a device of this type.

The microprocessor device 402 may be a general or special purpose microprocessor operating under control of computer program instructions executed from memory 404 on program data. The microprocessor 402 may include a number of special purpose sub-processors, each sub-processor for executing particular portions of the computer program instructions. Each sub-processor may be a separate circuit able to operate substantially in parallel with the other sub-processors. Some or all of the sub-processors may be implemented as computer program processes (software) tangibly stored in a memory 404 that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips.

Memory 404 may include both volatile and persistent memory for the storage of: operational instructions for execution by Microprocessor 402, data registers, application storage and the like. The computer instructions/applications that are stored in memory 404 are executed by processor 402. The I/O subsystem 406 may comprise various end user interfaces such as a display, a keyboard, and a mouse. The I/O subsystem 406 comprises a data network interface 490. The network interface 490 allows software and data to be transferred between the ECM 150 and external hosts or devices. Examples of network interface 490 can include one or a plurality of: Ethernet network interface card, wireless network interface card, network interface adapter via USB, wireless cellular modem, and the like. Data transferred via network interface 490 are in the form of signals which may be, for example, electronic, electromagnetic, radio frequency, optical, or other signals capable of being transmitted or received by network interface 490.

For purposes of this disclosure, the user's device 195 may also represent any type of computer, information processing system, or other programmable electronic device, including a client computer, a server computer, a portable computer such as a laptop device, an embedded controller, a software or microcode embedded in devices or appliances such as a mobile telephone such as an Apple iPhone, Television sets, Air Conditioning thermostats, home alarm systems, application-specific integrated circuit (ASIC), special-purpose microcontrollers, and the like that has been specially programmed to perform the functions of interfacing and communicating with the ECM 150 as disclosed herein.

KIT 1000

An embodiment of the present invention discloses a kit 1000 to be retrofitted into existing garage doors that are not made with the built in version, as in the previously discussed embodiments. Such kit 1000 would comprise: a one or more panel 120; a one or more rotating means 130; a one or more retracting means 140; a one or more electronics control module 150; and installation and mounting hardware. The kit 1000 may also comprise a housing 1100 surrounding the kit 1000 components.

Further, in view of many embodiments to which the principles of the invention may be applied, it should be understood that the illustrated embodiments are exemplary embodiments and should not limit the present disclosure.

Therefore, while there has been described what is presently considered to be the preferred embodiment, it will be understood by those skilled in the art that other modifications can be made within the spirit of the disclosure. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the disclosure.

1. An apparatus comprising:
a garage door having an at least one opening and an at least one hollow portion adjacent to said at least one opening and integral to said garage door;
a one or more panel integral to the garage door configured to span said at least one opening and enter said at least one hollow portion;
a rack and pinion system where said rack and pinion system is mechanically mounted integral to said garage door within said hollow portion and comprising:
a one or more rack fixedly attached to said garage door;
a one or more pinion mechanically communicative with said rack:
a pinion motor mechanically coupled to said one or more pinion; and
a pinion rod mechanically coupled to said one or more pinion configured to travel back and forth along said rack with said pinion; and
a rotating motor having a body and a shaft where said body is mechanically attached to said pinion rod and said shaft is mechanically attached to said panel.

2. The apparatus of claim 1 further comprising an electronics and control module electrically coupled to said pinion motor and said rotating motor.

3. The apparatus of claim 1 further comprising a one or more mesh screen.

4. A kit for retrofitting into existing garage doors, the kit comprising:
a one or more panel;
a one or more rotating means;
a one or more retracting means;
a one or more electronics control module; and
an installation and mounting hardware.

5. The kit of claim 4 further comprising a one or more mesh screen.

6. A system for selectively opening areas in a garage door having rotating and retractable panels, the system comprising:
a data network;
a one or more apparatus operatively coupled to said data network as a first node, wherein said apparatus comprises a garage door having a one or more panel integral to the garage door, a rotating means integral to the garage door and operably coupled to the one or more panel, a retracting means integral to the garage door and operably coupled to the one or more panel, and an electronics and control module operably coupled to the rotating means and the retracting means; and
a one or more user device operatively coupled to said data network as a second node.
